(19) United States
(12) Patent Application Publication
(10) Pub. No.: US 2009/0002574 A1
(43) Pub. Date: Jan. 1, 2009

(54) Method and a system for optical design and an imaging device using an optical element with optical aberrations

(75) Inventors: Noam Sorek, Zikhron-Yaakov (IL); Sharon Sade, Kfar-Yona (IL)

Correspondence Address: MARTIN D. MOYNIHAN d/b/a PRTSI, INC., P.O. BOX 16446, ARLINGTON, VA, 22215, US

(73) Assignee: Samsung Electronics Co., Ltd., Suwon-si (KR)

(21) Appl. No.: 11/819,961

(22) Filed: Jun. 29, 2007

(51) Int. Cl. H04N 5/74

(52) U.S. Cl. 348/784; 348/E05.137

(57) ABSTRACT

A method for designing an imaging device. The method comprises receiving specification of a final image mapping a three-dimensional environment according to a predefined mapping and an optical unit with an optical aberration. The method further comprises estimating an optical design of the optical unit with the optical aberration. The optical unit is configured for projecting a uncorrected initial image according to the optical aberration. The method further comprises calculating an algorithmic correction for the uncorrected initial image. The algorithmic correction is designed for compensating for the effect of the optical aberration on the uncorrected initial image. The method further comprises manufacturing the imaging device. The manufactured imaging device having the optical design and applying the algorithmic correction on the uncorrected initial image, thereby outputting the final image without the effect produced by said optical aberration and with said predefined mapping.

### FIELD AND BACKGROUND OF THE INVENTION

The present invention relates to a method and a system for a design of an imaging device and, more particularly, but not exclusively, to a method and a system for designing an optical unit and calculating a correction to one or more aberrations thereof.

In recent years, the demand for high performance compact digital imaging devices has increased. Such imaging devices convert an image of an intercepted scene to electronic signals by using an image sensor, such as a charge-coupled device (CCD) based sensor or a complementary metal-oxide semiconductor (CMOS) based sensor. In particular, the demand for high performance compact digital imaging devices, which are designed to be mounted in a compact device, such as a mobile phone, and have image sensors that have large number of pixels, more than two million pixels, is increasing. Such a demand is and outcome of the prevalence of mobile devices that incorporate digital cameras, such as laptops, webcams, mobile phones, personal digital assistants (PDAs) and the like.

The purpose of an imaging system is to collect a portion of light rays emanating from all object points in the filed of view, and then to redirect these rays so they reunited at their corresponding image points. However, due to diffraction, all imaging systems have a certain level of blurring. Moreover, imaging systems also suffers from optical aberrations which further blur the image. The equations describing the optical aberrations of a lens are non-linear functions of the lens constructional parameters such as surface curvature, thicknesses, glass indices and dispersion, etc. As further described below, there are two chromatic aberrations: longitudinal and transverse chromatic aberration. The five primary monochromatic aberrations, which are also known are third order monochromatic aberrations, are spherical aberration, Coma, Astigmatism, Field curvature, and distortion.

Imaging devices may include algorithms for correcting the monochromatic aberrations. Typically, a third order warping transformation is used to determine the amount of curvature resulting from the distortion and to create a corrected image that closely models the actual exposed image. Generally, these techniques involve exposing the lens to a square or rectangular shape and determining the amount of curvature that results from the distortion.

An example of a method for correcting lens distortion is disclosed in U.S. Pat. No. 6,002,525, issued on Dec. 14, 1999 that describes a method for correcting lens distortion using a least squares curve fitting method to determine a straight line approximation for the curvature caused by lens distortion. An image made of a rectangular shape formed from a series of circles may be utilized as the target for a picture that is taken to calibrate for lens distortion. The deviation of each of the straight lines is caused by the lens distortion is calculated assuming that the optical axis is centered on the image. The presumed optical axis is adjusted towards the sides of the rectangle with the lower values of distortion coefficient. When the lines agree the optical axis has been located. The deviation is measured perpendicularly from a best-fit straight-line approximation.

Another class of optical aberrations is chromatic aberrations. Chromatic aberrations may be understood as the optical aberrations due to the dependency of the refractive index of the lens on the wavelength, the color dispersion, or use of diffractive optical element.

Great efforts are currently required to design an overall well-corrected lens that brings all colors together in the same focus. For example, obliquely incident light leads to the transverse chromatic aberration that is also known as lateral color or the inability of a lens to focus different colors in the same focal plane that leads to the longitudinal chromatic aberration that is also known as axial color.

Methods and processes for designing optical elements with reduced or eliminated chromatic aberrations, such as lateral color, are known.

It should be noted that the optical aberrations not only reduce resolution but also cause uneven resolution across the field of view (FOV) of the display at one or more colors.

After a basic design of a lens is generally determined, the lens designer or optimization software ordinarily tries to optimize its performance by minimizing optical aberrations.

An example of a method apparatus for optimizing optical unit with program for optimizing optical unit is disclosed in U.S. Pat. No. 6,895,334, issued on May 17, 2005 that describes the optimization of optical properties with high non-linearity such as a modulation transfer function (MTF) at high speed compared to conventional methods. An optimal or approximately optimal solution of an optical unit is obtained in a first optimization unit using a merit function on optical aberrations. Weights or target values of the merit function on aberration are automatically adjusted in a second optimization unit in a manner that an evaluated value of the MTF or the like approaches a desired value. The first optimization unit re-optimizes the optical unit using the weights or target values that have been automatically adjusted.

Though systems for optimizing optical units, as exemplified above, assist during the optical design of optical elements, such as lenses for high performance compact digital imaging devices, the optical designer is still required to make substantial efforts in order to finalize the design. It should be noted that such a finalizing of the optical design does not necessarily achieve desired performance.

Optical design of a high performance compact digital imaging devices is done under many constraints such as size and the required optical characteristics of the optical unit. For example, in the cellular arena, the optical design of an imaging system is done under a limiting size constraint, as the optical module has to fit a small space that is allocated thereto in the cellular phone. This requirement is orthogonal and sometimes contradicts to the required optical characteristics of the optical design. Moreover, in order to design small sized optics one needs to bend light rays in sharp angles. In the light of such constraints, the aforementioned optical designer is required to make even more efforts in order to finalize the optical design of the optical elements. In order to comply with such constraints, the optical designer may even be required to use lenses, which are made of a material with high refractive index that usually have high color dispersion and tendency to chromatic aberrations. The effect of such constraints may even be more pronounced when wide FOV (WFOV) lenses are used.

### SUMMARY OF THE INVENTION

According to one aspect of the present invention there is provided an imaging apparatus for outputting a final image having a predefined mapping. The imaging apparatus comprises an image sensor, an optical unit having an optical aberration, which is designed for projecting a uncorrected initial image on the image sensor. The imaging apparatus further comprises an optical algorithmic correction module, operatively connected to the image sensor, which is designed for compensating for the effect of the optical aberration on the uncorrected initial image according to at least one parameter defined according to the optical aberration. In such a manner, the optical algorithmic correction allows the outputting the final image without the effect produced by the optical aberration and with the predefined mapping.

According to another aspect of the present invention there is provided an imaging apparatus for outputting a final image having a predefined mapping. The imaging apparatus comprises an image sensor, an optical unit having an image distortion aberration above 5%, configured for projecting an uncorrected initial image on the image sensor, and an optical algorithmic correction module that is operatively connected to the image sensor. The optical algorithmic correction module compensates for the effect of the optical aberration on the uncorrected initial image, thereby allowing the outputting the final image without the effect of the optical aberration and with the predefined mapping.

According to another aspect of the present invention there is provided an imaging apparatus for outputting a final image having a predefined mapping. The imaging apparatus comprises an image sensor, an optical unit having a chromatic optical aberration, configured for projecting a uncorrected initial image with lateral color wider than an Airy disc of the image sensor. The imaging apparatus further comprises an optical algorithmic correction module, which is operatively connected to the image sensor, configured for compensating for the effect of the optical aberration on the uncorrected initial image, thereby allowing the outputting the final image without the effect of the optical aberration and with the predefined mapping.

According to another aspect of the present invention there is provided an imaging apparatus for outputting a final image having a predefined mapping. The imaging apparatus comprises an image sensor, an optical unit having a chromatic optical aberration, configured for projecting a uncorrected initial image with a first area and a second area on the image sensor, the first and second areas having different resolutions, and an optical algorithmic correction module, operatively connected to the image sensor, configured for compensating for the effect of the optical aberration on the uncorrected initial image, thereby allowing the outputting the final image without the effect of the optical aberration and with the predefined mapping.

According to another aspect of the present invention there is provided a method for designing an imaging device. The method comprises a) receiving specification of a final image mapping a three-dimensional environment according to a predefined mapping and an optical unit with an optical aberration, b) estimating an optical design of the optical unit with the optical aberration, the optical unit is configured for projecting a uncorrected initial image according to the optical aberration, c) calculating an algorithmic correction for the uncorrected initial image, the algorithmic correction is configured for compensating for the effect of the optical aberration on the uncorrected initial image, and d) manufacturing the imaging device, the manufactured imaging device having the optical design and applying the algorithmic correction on the uncorrected initial image, thereby outputting the final image.

According to another aspect of the present invention there is provided a system for designing an imaging device. The system comprises an input module configured for receiving a specification of a final image mapping a three-dimensional environment according to a predefined mapping an optical unit having an optical aberration. The system further comprises an optical design module for providing an optical design of the optical unit having the optical aberration, the optical unit is configured for projecting a distorted initial image. The system further comprises an algorithmic correction module for generating an algorithmic correction for compensating for the effect of the optical aberration on the image, the algorithmic correction is defined according to the predefined mapping and the optical aberration. In addition, the system further comprises an output module for outputting the optical design and the algorithmic correction, thereby allowing the manufacturing of an imaging device configured for outputting the final image.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several projects of the invention may be embodied in practice.

In the drawings:

FIG. 1 is a flowchart that depicts a method for designing an optical unit of an imaging device and calculating a correction thereto, according to one embodiment of the present invention;

FIG. 2 is a sectional illustration of an imaging device that is designed using to the method for designing an optical unit of FIG. 1, according to one embodiment of the present invention;

FIG. 3 is a graph of a predefined image distortion that is defined in terms of FOV as a function of the number of pixels, which are used for reproducing the space image that is depicted in the FOV;

FIGS. 4A and 4B are graphs that provide exemplary modulation transfer function (MTF) values as function of the spatial resolution for the projection of light beams, which are centered on red, green and blue wavelengths;

FIG. 5 is a flowchart of an optical design process, according to one embodiment of the present invention;

FIG. 6 is a flowchart that describes a process for generating an optical aberration correction that reduces or eliminates the effect of the predefined optical aberrations on the uncorrected initial image, according to one embodiment of the present invention;

FIG. 7 is a flowchart that depicts a process for identifying a correction to an image distortion aberration, according to one embodiment of the present invention;

FIG. 8 is a flowchart that depicts a process for identifying a correction to a lateral color aberration, according to one embodiment of the present invention;

FIG. 9 is a schematic illustration of an imaging device that is designed for outputting an image, according to one embodiment of the present invention; and

FIG. 10 is a schematic illustration of a system for designing an imaging device having an optical unit that projects an uncorrected initial image on a sensor, according to one embodiment of the present invention.

### DESCRIPTION OF THE EMBODIMENTS

The present embodiments comprise a system and a method for designing an imaging device, such as a camera, with an optical unit, such as a lens assembly, with one or more optical aberrations, such as image distortion and lateral color, optionally predefined in the optical design stage.

The method comprises a number of steps. During the first step, a specification that defines a final image that maps a three-dimensional environment according to a predefined mapping is provided. The three-dimensional environment may include one or more objects. Light reflected from each object may have a different projection, as further described below. Additionally, the specification defines or an optic unit with one or more optical aberrations. The optical unit projects uncorrected initial image, which is hampered by the optical aberrations. The specification may regard to the characteristics of the image sensor which is used in the imaging device. After the specification has been received, the optical design of the optical unit with the predefined optical aberrations is estimated. Optionally, the uncorrected initial image is hampered in a manner that different areas thereof have different resolutions. In addition, an algorithmic correction for the uncorrected initial image is calculated. The algorithmic correction compensates for the effect of the optical aberrations on the uncorrected initial image and allows the designed imaging device to output of a final image with the predefined mapping. Different algorithmic corrections may provide different final images with different mappings. The predefined optical aberrations are optimal for projecting an uncorrected initial image with image distortions that may be corrected algorithmically. For example, we may use a lens with predefine optical aberrations, which are optimal for projections light from one or more of the following objects: rectilinear objects, cylindrical objects, multi-planar objects, which are also known as rectilinear objects, ellipsoidal projections, etc. The optical design and the algorithmic correction allow the manufacturing of imaging device that may produce the aforementioned final image. As the optical unit has optical aberrations and optionally projects an uncorrected initial image with uneven resolution, parameters of the optical design of the optical unit may be chosen more flexibly.

In such a manner, the optical design allows using compact lenses, optionally wide, which are adjusted to the size limitations of mobile phones. For example, the optical unit is designed according to an optic design that defines an optical unit with WFOV and small dimensions. It should be noted that an optical unit with WFOV may be understood as an optical unit with a field of view of more than 60 degrees. The designed optical unit projects an uncorrected initial image that is hampered by the optical aberrations. In one embodiment of the present invention, the optical aberrations comprise monochromatic aberrations, such as a predefined level of image distortion, and predefined chromatic aberrations, such as a predefined level of lateral color.

According to another aspect of the present invention, there is provided an imaging device for outputting or acquiring an uncorrected initial image. Optionally, the uncorrected initial image is formed with an uneven resolution, optionally defined in the optical design stage. The imaging device comprises an image sensor, an optical unit with one or more optical aberrations that have been defined in the design stage, which are designed for projecting the uncorrected initial image on the sensor, and an algorithmic correction module for compensating for the effect of the optical aberration on the uncorrected initial image. The compensation is determined according to one or more parameters, which are adjusted according to the optical aberrations. Optionally, the optical unit with the predefined optical aberrations projects an uncorrected initial image having areas with uneven resolution. In such an embodiment, the module is designed for compensating for areas with uneven resolution in the uncorrected initial image, thereby creating a final image with even resolution. For example, the uncorrected initial image may have a high resolution across the field in one of the red, blue, and green wavelengths while having low resolution in the other two wavelengths. The module uses an algorithmic correction that corrects the uneven resolution in the uncorrected initial image by compensating for the information that is absent in the low-resolution wavelengths by acquiring respective information that is present in the high-resolution wavelengths, as further described below. In another example, the uncorrected initial image may have uneven resolution in different colors with respect to the distribution of pixels across the field of the uncorrected initial image.

The generation of such an embodiment becomes possible, inter alia, using the aforementioned system and a method for designing an imaging device, as described below. The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

An optical unit may be understood as an assembly of one or more lenses, prisms, diffractive elements, mirrors or optical objects that is intended to produce an image.

Monochromatic aberrations may be understood as aberrations produced without dispersion such as piston, tilt, defocus, spherical, coma, astigmatism, curvature of field, image distortion, and aberrations at reflecting surfaces of monochromatic light of single wavelength.

Chromatic aberrations may be understood as aberrations produced where an optical unit disperses various wavelengths of light, such as axial, or longitudinal, chromatic aberration and lateral, or transverse, chromatic aberration.

Optical aberrations may be understood as monochromatic aberrations, chromatic aberrations, or any combination thereof.

An imaging device may be understood as a unit, such as a camera of a mobile phone, that comprises a display or a sensor, for example an industry-standard color mosaic sensor, such as the Bayer-type sensor and an optical unit that comprises one or more optical elements known in the art, which are able to project, separately or in combination, a space image on the display or the sensor. Typically, the one or more optical elements comprise one or more simple or compound lenses and one or more mirrors. The optical unit may be implemented from industry-standard elements, custom-built elements, or a combination of industry-standard and custom-built elements.

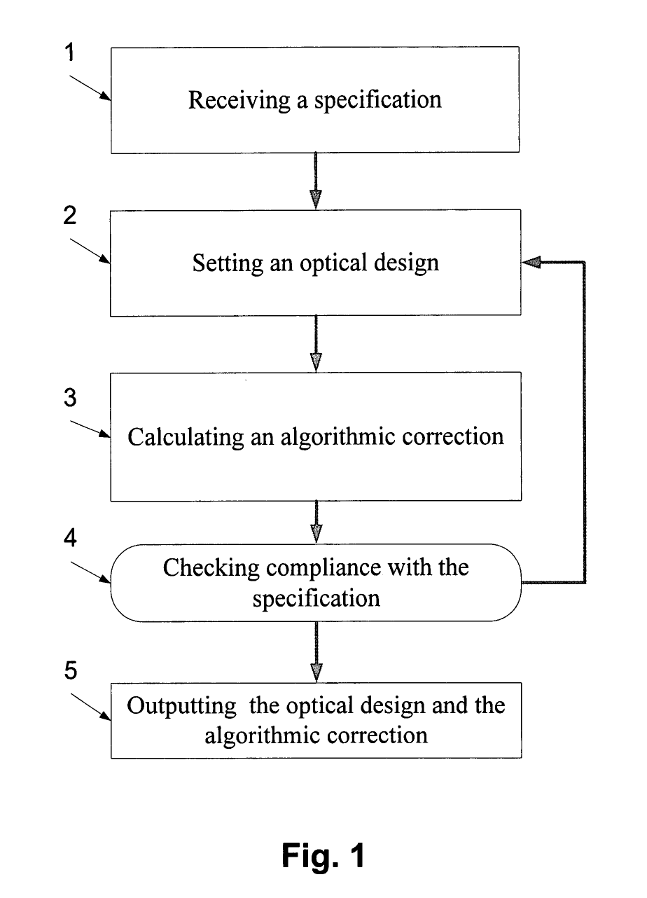

Reference is now made to FIG. 1, which is a flowchart that depicts a method for designing an optical unit of an imaging device and calculating an algorithmic correction thereto, according to one embodiment of the present invention. During the first step, as shown at 1, a specification that defines one or more optical aberrations in components of the optical unit or image distortions produced by such optical aberrations is received. The specification further defines a final image that maps a three-dimensional environment according to a predefined mapping,

The defined specification depends on the required applications of the imaging device, for example, a minimum depth of field (DOF) distance, a predefined focal length, or a field of view. Optionally, the specification is defined with respects to the performances and structure of an image sensor, such as a Bayer sensor, which is projected with the uncorrected initial image. In one embodiment of the present invention, the imaging device is designed to be incorporated into a cellular phone or the like. In such an embodiment, the specification limits the mechanical space of the optical unit.

Optionally, the specification defines an optical unit with one or more optical aberrations that project an uncorrected initial image, optionally on a sensor, and a final image that maps a three-dimensional environment according to a predefined mapping. Each optical aberration is defined with a certain constant value or a range of possible values. Each optical aberration may be a monochromatic aberration, such as an image distortion aberration or a chromatic aberration, such as a lateral color aberration. For clarity, it should be noted that image distortion, denoted as a percentage, may be defined as the real chief ray height, minus the reference ray height, divided by the reference ray height, times 100:

$$distortion = 100 \times \frac{{y}_{chief} - {y}_{ref}}{{y}_{ref}}$$

where all heights are taken to be the image surface radial coordinate, at whatever image surface is defined as the data is not referred to the paraxial image surface. The reference ray height is computed by tracing a real ray from a very small field height, and then scaling the results as required. The reference height for the undistorted ray in a rotationally symmetric system at paraxial focus is given by:

y_{ref}=f tan θ

where f is the focal length and θ is the angle in object space.

Optionally, the optical unit is defined with an image distortion aberration of more than five percent. In such an embodiment, the image distortion is defined as described above and set forth in p. 166-167 of the ZEMAX User's Guide, published on May 15, 2007, which is incorporated herein by reference. In addition, the specification may define uneven resolution at different areas of the uncorrected initial image, as further described below.

Optionally, the optical unit is defined with an image distortion aberration of less than 2% and relatively high lateral color aberration, resulting from the misalignment of refracted light. The optical unit is designed to provide a narrow FOV projection with a linear behavior.

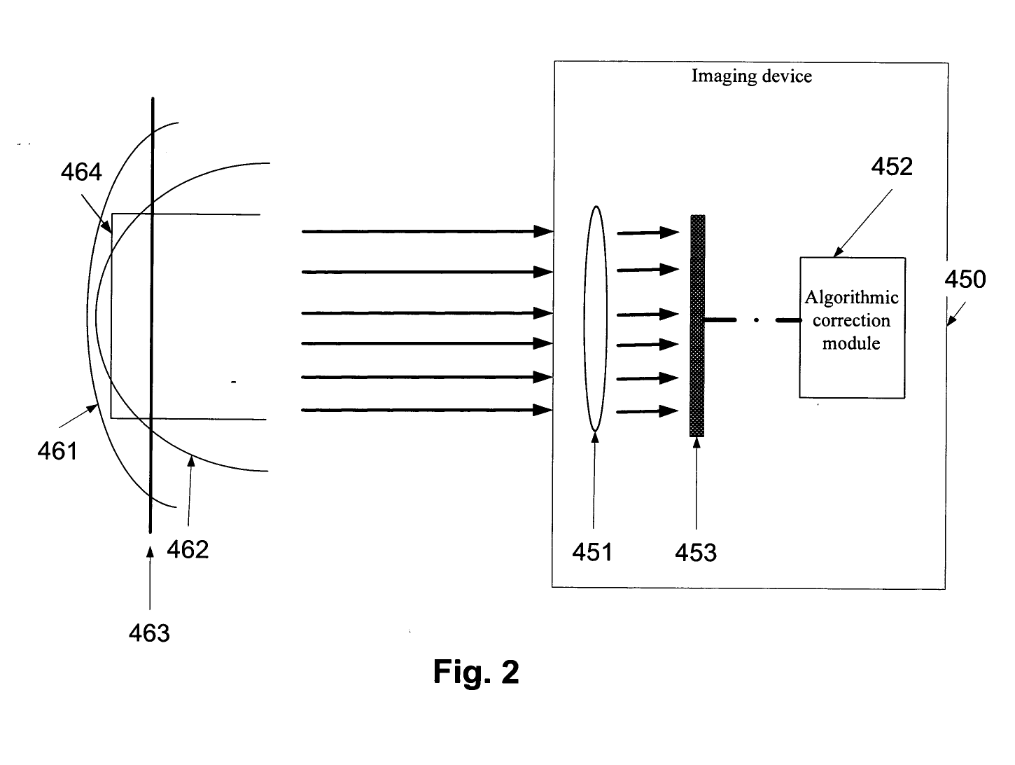

Reference is now made to FIG. 2, which is a sectional illustration of an imaging device that is designed according to the method that is described in FIG. 1, according to one embodiment of the present invention. The imaging device 450 comprises an optical unit 451 that has been designed according to the aforementioned optical design, an algorithmic correction module 452 that is defined according to the aforementioned algorithmic correction, and an image sensor 453, such as a Bayer sensor. In use, the light, which is received through the optical unit 451, is projected on the image sensor 453, forming the aforementioned uncorrected initial image that is hampered by the aforementioned predefined optical aberrations on the surface thereof. The algorithmic correction module 452 applies the algorithmic correction on the uncorrected initial image and outputs the final image with the aforementioned predefined mapping, wherein the effects of the predefined optical aberrations are corrected. In such an embodiment, the optic unit 451 may be adjusted with predefined optical aberrations that facilitate an optical design of an optic unit that is adjusted to receive projections from objects with one or more geometrical shapes. Optionally, the optical unit 451 is designed according to an optimal weight that is adapted for all the received projections. Such objects may be ellipsoidal objects 461, cylindrical objects 462, multi rectilinear objects 463, or rectilinear objects 464. Optionally, the algorithmic correction module 452 is designed to handle different projections of different objects, which are captured by the optic unit 451.

Reference is now made, once again, to FIG. 1. It should be noted that the optical unit is either arranged or simulated by an optic design module, as described below. Respectively, the uncorrected initial image is either formed by the optical unit or simulated using the parameters of the optical design of the optical unit, as described below.

For example, the predefined optical aberrations, which are defined in the specification, are an image distortion aberration that is evaluated in terms of FOV as function of the position of the uncorrected initial image on the sensor and a lateral color aberration. Optionally, the specification further defines uneven resolution at different areas of the uncorrected initial image. The uneven resolution may be with respect to distribution of different wavelengths across the field of the uncorrected initial image or with respect to distribution of pixels across the field of the uncorrected initial image. The image distortion aberration causes the uncorrected initial image to have a linear functional behavior in the midfield of the FOV and a non-linear behavior, such as a second order polynomial orientation, in the edges thereof. Such optical aberrations and uneven resolution allows more flexibility during the optical design step, for example during the designing of a small sized camera module or an optical imaging device with WFOV, as described below.

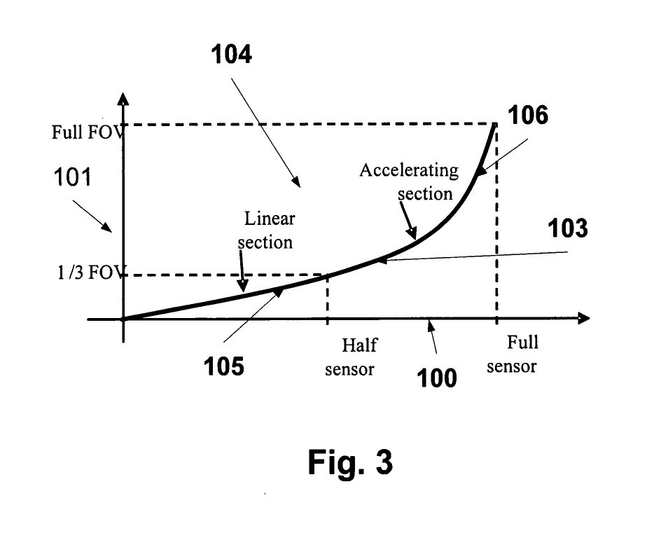

For example, reference is now made to FIG. 3, which is a graph 104 of a predefined image distortion that is defined in terms of FOV 100 as a function of the number of pixels, which are used for reproducing the space image that is depicted in the FOV 101. The Y-axis of the graph denotes the portion of the total FOV that is formed by the sensor and the X-axis of the graph denotes a number of pixels from the total number of pixels. The pixels are accumulated from the image center of the sensor to the edges of the sensor.

The curve 103 in the graph 104 depicts predefined image distortion having a linear functional behavior in the midfield of the FOV 105 and non-linear behavior, such as a second order polynomial orientation, in the edges of the FOV 106. The center of the FOV, which is approximately third of the total area of the FOV, is captured by pixels from the center of the sensor. As each pixel captures approximately the same area, there is no barrel or pincushion distortion in the image captured by the pixels in the center of the sensor. As far as the pixels are situated from the center of the sensor, the wider is the area of the FOV that they cover. The other two thirds of the FOV are captured by the peripheral areas of the sensor.

In one embodiment of the present invention, the specification defines chromatic optical aberrations, such as a lateral or axial color. Optionally, the specification defines the difference in image height or in the focal length between monochromatic light beams centered on different wavelengths, which have been split by the optical unit from a common ray of light. Briefly stated, light beams, which are diffracted from the same ray of light, are at least one pixel apart one from another. Optionally, the range is determined with respect to a related Airy disc and preferably wider then the perimeter thereof. Optionally, the specification defines the aforementioned difference in image height.

Optionally, as described above, the specification defines uneven resolution at different areas of the uncorrected initial image. Optionally, the uncorrected initial image is a chromatic space image that comprises a number, optionally three, of monochromatic space images. Each monochromatic space image is simulated or formed according to projections of a monochromatic light beam that is centered on a specific wavelength. Optionally, the uncorrected initial image is designed to be projected on a sensor with a Bayer pattern filter mosaic, which may be referred to as a Bayer sensor. In such an embodiment, the structure of the Bayer filter mosaic is taken into account in the algorithmic correction, as described below.

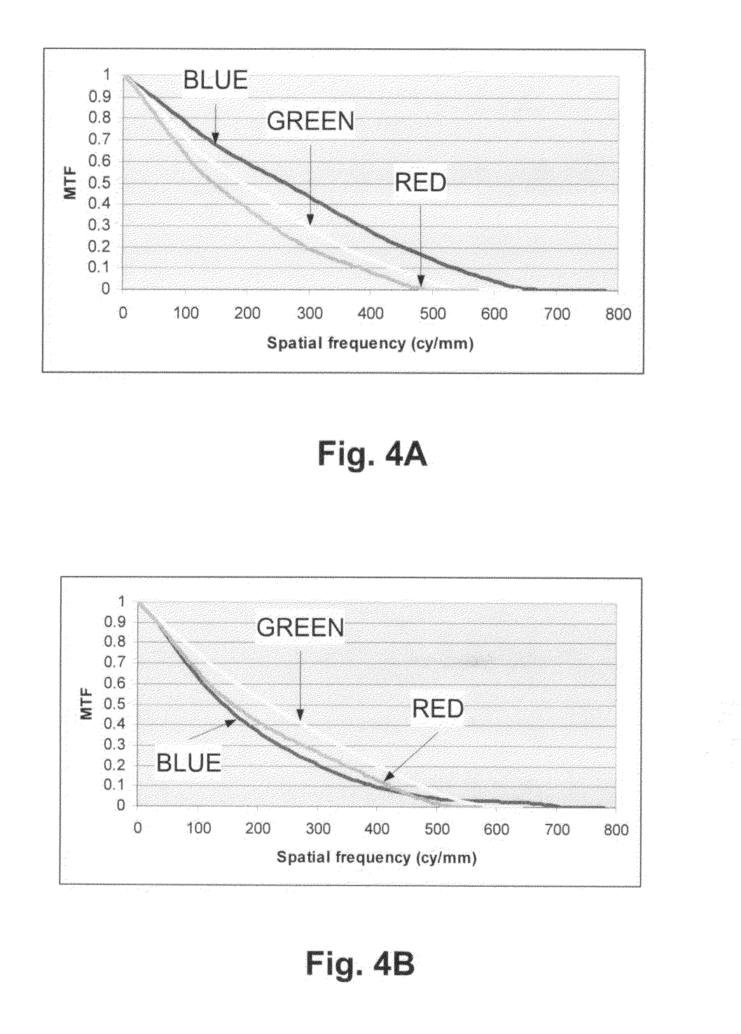

Optionally, the specification defines uneven resolutions to areas in the chromatic space image in a manner that for each area high resolution is defined in one of the monochromatic space images. The resolution may be measured, for example, using a modulation transfer function (MTF) or a point spread function (PSF). An example for initial requirements that define such uneven resolution is depicted in FIGS. 4A and 4B, which are graphs that provide exemplary modulation transfer function (MTF) values as function of the spatial resolution for the projection of light beams, which are centered on red, green, and blue wavelengths. FIGS. 4A and 4B depict three sets of point pairs. Each point pair represents a measure of a spatial detail, as denoted on the x-axis, and the extent of preservation of that detail, optionally measured on a modulation transfer, as denoted on the Y-axis. In FIG. 4A, the MTF values are defined as function of the spatial resolution for all three colors at the center field, which may be understood as field of 0°. As depicted, the blue color has the highest resolution in the center field whereas the red and green has lower resolution. On the other hand, FIG. 4B depicts the MTF values as function of the spatial resolution for all three colors at the corner field, which may be understood as 75°. As depicted, the green color at the corner field has the highest resolution whereas the red and blue has lower resolution.

Optionally, the specification defines uneven resolutions of the optical unit with respect to high resolution which can be defined by MTF values of at least 45% contrast at a frequency of half Nyquist of the sensor or the optics, the lower of the two.

Reference is now made, once again, to FIG. 1.

As shown at 2, after the specification has been received, an optical design of a designated optical unit having the specified optical aberrations that projects the uncorrected initial image is provided. The optical design allows optical aberrations and optionally uneven resolution at different areas of the uncorrected initial image, as defined at the specification. For example, in one embodiment of the present invention, the optical design allows an image distortion in a certain range and uneven resolution at different areas of the uncorrected initial image, while all other required optical parameters have optimal or approximately optimal values. In such an embodiment, the distortion of the uncorrected initial image has a specific behavior across the FOV that is optimal or approximately optimal to the required image distortion at the uncorrected initial image and to the performances of a process for correcting the optical aberrations and uneven resolution, which are defined in the specification. For example, the lateral color of the uncorrected initial image is designed to allow the process for correcting the optical aberrations to achieve negligible lateral color.

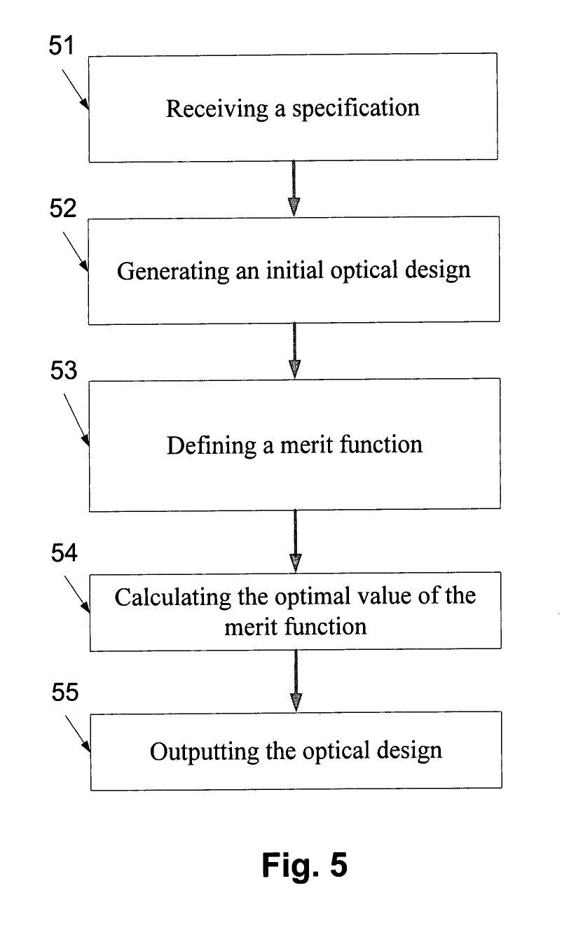

Reference is now made to FIG. 5, which is a flowchart of an optical design process, according to one embodiment of the present invention. To begin with, as shown at 51, the specification is received. Then, as shown at 52, an initial optical design is generated. Optionally, the initial optical design has almost the same parameters as a final design but it is not yet optimized to have the optimal values of the optical parameters and aberrations. Then, as shown at 53, a merit function of the optical design of the designated optical unit is defined with respect to the initial requirements that comprise parameters such as a root mean square (RMS) spot radius, thicknesses, areas with uneven resolutions, image distortion aberration, etc.

As commonly known, the merit function:

$${MF}^{2} = \frac{\sum {{w}_{i} ( {f}_{i} - {t}_{i} )}^{2}}{\sum {w}_{i}} ,$$

where i indicates an operand number, such as a row number in the designer spreadsheet, wᵢ denotes an absolute value of the weight of operand i,f denotes a current value, and t denotes a target value. Optionally, the sum index “i” is normally over all operands in the merit function, however the merit function listing feature sums the user defined and default operands separately, see chapter “Merit Function Listing” on page 211 of Zemax™ manual, published in September 2006, which is incorporated herein by reference.

During the following step, as shown at 54, the temporary evaluated value with which the merit function has the minimum point is calculated. The operation to seek the minimum point of the merit function by varying parameters may be referred to as lens optimization or optical unit optimization. Optionally, parameters of the structure of the optical unit, such as the length of the air gaps between the lenses, and parameters of each one of the lenses of the optical unit, such as, the thickness, the radius, the aperture, the conic constant, or the aspheric coefficients of each one of the lenses are changed, optionally iteratively, for achieving optimal or approximately optimal merit function value. There are many algorithms for minimizing the merit function such as a damped least squares (DLS) method or a quasi-Newton method, see Robert R. Meyer et al., Modified Damped Least Squares: An Algorithm for Non-linear Estimation, IMA Journal of Applied Mathematics 1972 9(2):218-233, which is herein incorporated by reference.

Optionally, a number of lens configurations are checked against the merit function with the specified ranges of optical aberrations. Each lens configuration comprises one or more lenses. Each lens is represented by a number of parameters. During each check, the parameters of the lenses of a certain lens configuration are substituted in the tᵢ variables of the merit function and the agreement between them and the specified ranges of optical aberrations is measured. By comparing the outcome of the merit function for different lenses, one may determine the lens configuration that results the optimum optical design, considering the specified ranges of optical aberrations. Optionally, as described above, a lens configuration wherein the parameters of the lenses provide the smallest outcome of the merit function is chosen as the optical design of the designated optical unit. In use, such a designated optical unit is used for reproducing or simulating the uncorrected initial image.

In the final step, as shown at 55, the optical design of the designated optical unit is outputted, optionally as the parameters of the lenses or optical elements.

Reference is now made, once again, to FIG. 1.

After the optical design of the designated optical unit has been estimated, an algorithmic correction for the uncorrected initial image is calculated, as shown at 3. The algorithmic correction compensates for the effect of the optical aberrations and optionally corrects the uneven resolution in the uncorrected initial image. As described above, the uncorrected initial image is formed using the designated optical unit. The algorithmic correction is designed for correcting the uncorrected initial image in a manner that reduces or eliminates the effect of the predefined optical aberrations of the optical unit thereon. The algorithmic correction is further designed for correcting the uncorrected initial image in a manner that the corrected uncorrected initial image maps a three-dimensional environment according to the predefined mapping that has been provided in the specification. The corrected uncorrected initial image may be understood as the final image that is outputted by the imaging device that comprises the designated optical unit.

Optionally, a number of algorithmic corrections are calculated during this step. Optionally, each one of the algorithmic corrections is defined to allow the generation of a different final image that maps a three-dimensional environment according to different predefined mappings. Optionally, the imaging device of the designed optical unit is adjusted to use a different algorithmic correction for a different mode. For example, a certain algorithmic correction may be used for correcting a picture taken from a close distance and another algorithmic correction applied for correcting a picture taken from a far.

Optionally, the algorithmic correction is designed for correcting an uncorrected initial image that has been projected on and captured by a color-filtered image sensor, such as a Bayer sensor. As commonly known, there are a number of different ways the pixel filters are arranged in practice. For example, in the Bayer sensor, the color filters alternate values of red and green for odd rows and alternating values of green and blue for even rows. Since each pixel of the sensor is behind such a color filter, the output of the sensor is an array of pixel values, each indicating a raw intensity of one of three primary colors. Thus, an algorithm, which may be referred to as demosaicing algorithm, is used for estimating for each pixel the color levels for all color components, rather than a single component. The demosaicing algorithm, which is also known as a CFA interpolation or a color reconstruction, interpolates a complete image from the partial raw data received from the color-filtered image sensor. As described above, the uncorrected initial image is hampered by predefined chromatic aberrations, such as lateral color. Optionally, the effect of such predefined chromatic aberrations is corrected using a preliminary algorithmic correction before the demosaicing algorithm is applied on the uncorrected initial image. In such a manner, the effect of the predefined chromatic aberration on the values of different pixels in the uncorrected initial image is reduced or removed before the interpolation of the demosaicing algorithm. For example, the preliminary algorithmic correction may reduce or remove the effect of the lateral color aberration on the uncorrected initial image. Optionally, the uncorrected initial image is divided to segments and the preliminary algorithmic correction is sequentially applied on each one of the segments. A segment may be understood as a pixel or a group of pixels, such as a row or a column, of the uncorrected initial image. In such an embodiment, the size of the memory which is needed for applying the preliminary algorithmic correction is limited to the size of the segment and therefore smaller than the memory which is needed for simultaneously applying the preliminary algorithmic correction to all the pixels of the uncorrected initial image.

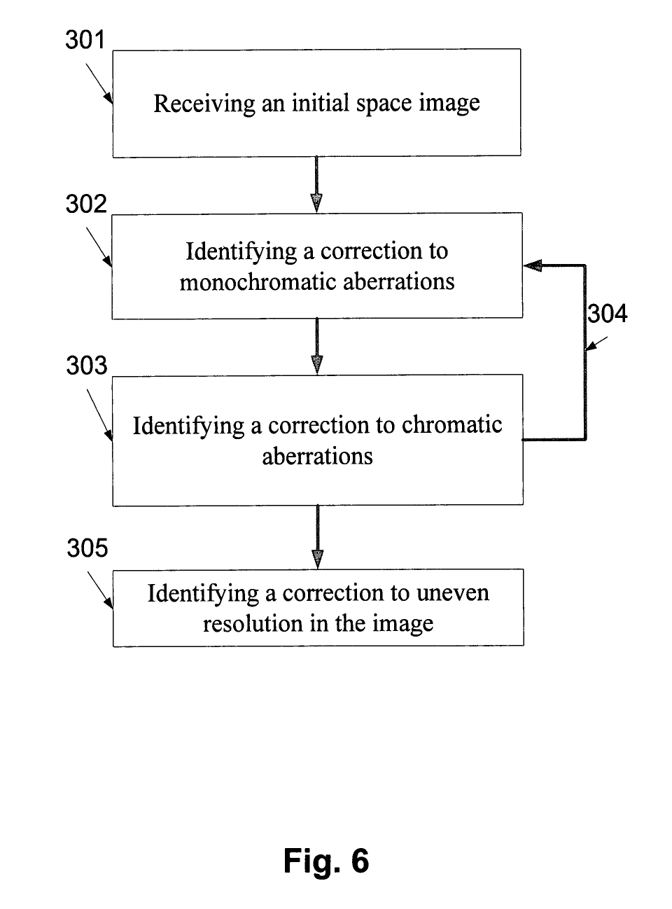

Reference is now made to FIG. 6, which is a flowchart that describes a process for generating an optical aberration correction that reduces or eliminates the effect of the predefined optical aberrations on the uncorrected initial image, according to one embodiment of the present invention. During the first step, as shown at 301, the aforementioned uncorrected initial image is received. As described above, the uncorrected initial image is formed on a sensor according to projections of an optical unit having predefined optical aberrations. In use, the sensor forwards the formed image to a designated module, as described below. Optionally, the uncorrected initial image is simulated according to the aforementioned parameters. Then, as shown at 302, a monochromatic algorithmic correction to one or more predefined monochromatic aberrations in the optical unit, such as an image distortion, is identified.

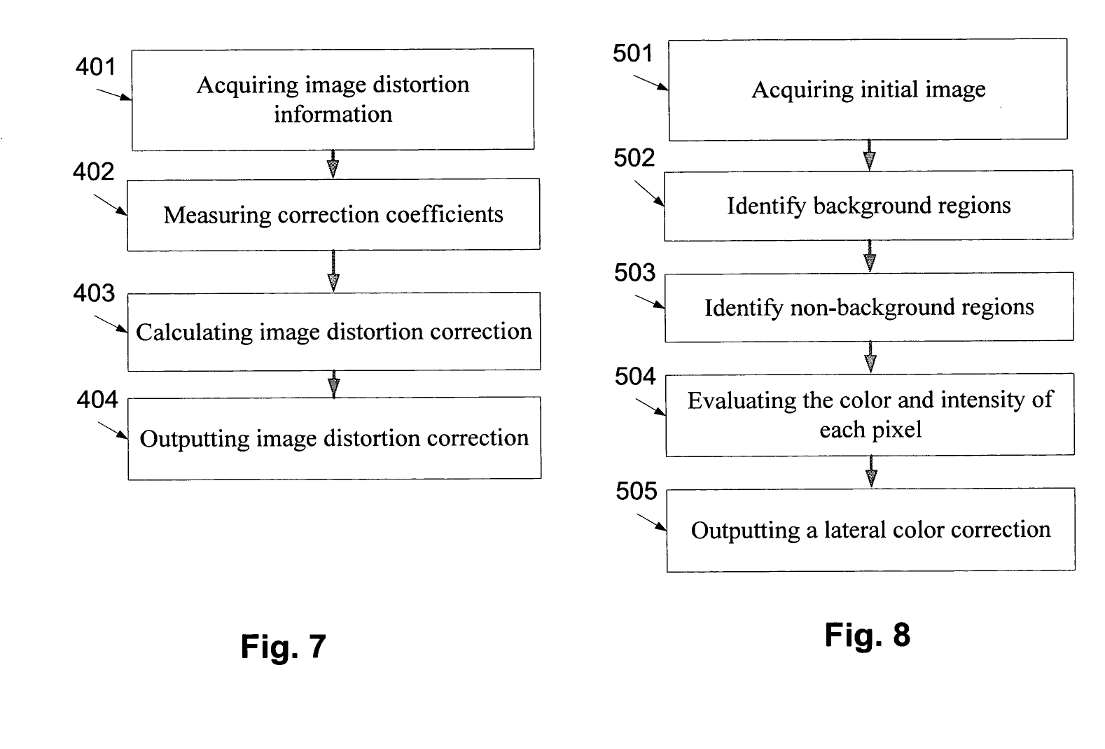

Reference in now made to FIG. 7, which is a flowchart that depicts a process for identifying an algorithmic correction to an image distortion aberration, according to one embodiment of the present invention.

During the first step, as shown at 401, image distortion information about the image distortion aberration of the optical unit is acquired. Optionally, the distortion information is acquired from the aforementioned parameters of lens of the designated optical unit. Optionally, the distortion information is acquired by reproducing an image of a calibration grid using the designated optical unit from the parameters of the optical design. The calibration grid is most optionally implemented as a set of transparent horizontal and vertical lines on a substantially opaque background, where the lines projecting a substantially square array. Lines are most optionally blurred at their edges, to prevent aliasing of an image produced by grid. As described above, the images formed by the designated optical unit are optionally affected by the predefined image distortion aberration thereof. Thus, the location of a group of nodes from the calibration grid is generally displaced relative to the nodes of the calibration grid itself. The offsets between the nodes of the calibration grid and the nodes, which are depicted in the image thereof, represent the image distortion. Optionally, the calibration is performed a number of times. For example, one calibration for allowing the imaging device to project an image of close objects, for example, objects which are located less than 10 centimeters from the optic unit and another calibration for allowing the imaging device to project an image of objects, which are located more than 10 centimeters from the optic unit.

During the following step, as shown at 402, a set of coefficients that compensate for the offsets, thereby reducing or eliminating the effect of the image distortion aberration is calculated for each node. Optionally, the coefficients of each node are calculated and analyzed separately for each color plane, such as R, G, and B, in order to locate the offsets from the calibration grid. Each one of the color planes is formed according to monochromatic light beams, which are centered on a respective wavelength.

As shown at 403, the coefficients are used for calculating the aforementioned image distortion correction that is designed for correcting the effect of the image distortion aberration of the designated optical unit. The distances between every two adjacent nodes of the image grid are calculated and the location of each pixel in the uncorrected initial image is corrected to its undistorted position. The correction is optionally calculated using an undistorted field that is used as a reference point. The undistorted field is calculated according to the aforementioned distances and taken from the center of the uncorrected initial image. The image distortion correction is based on the acquired distortion information. The image distortion correction, which is optionally outputted, as shown at 404, allows the generation of the output image without or approximately without image distortion. The image distortion correction is optionally a set of vectors, wherein each vector defines the deviation between the location of a pixel in the uncorrected initial image and the undistorted position of the output image that does not influenced by the projection of the image distortion aberration of the optical unit.

Reference is now made, once again, to FIG. 6. After the monochromatic correction to the monochromatic aberrations has been identified, optionally as described above, a chromatic correction to the chromatic aberrations is identified, as shown at 303. It should be noted that step 303 may be held before step 302.

As described above, the optical unit may be designed with one or more chromatic aberrations, such as lateral color or axial color aberration. A chromatic correction to the chromatic aberrations is optionally identified using methods known at the field of optical design. In one embodiment of the present invention, the chromatic correction is designed to eliminate or to reduce the effect of the lateral color aberration or the axial color aberration of the designated optical unit on the uncorrected initial image.

Reference in now made to FIG. 8, which is a flowchart that depicts a process for identifying a correction to a lateral color aberration or an uneven resolution aberration, according to one embodiment of the present invention.

The process for identifying the chromatic correction that reduces or eliminates the effect of the lateral color aberration is based on a number of steps. In the first step, as shown at 501, the uncorrected initial image is received. Optionally, the effect of the monochromatic aberrations on the initial space is reduced using the aforementioned monochromatic correction. Then, as shown at 502, the uncorrected initial image is analyzed to determine one or more regions that contain mainly background color. The analysis is most optionally implemented by finding regions where the change in signal level from a pixel with a specific color, such as R, G, or B, to a pixel with the same color that is a closest-neighbor thereof is relatively low, indicating that the region being imaged comprises substantially one color. Averages, herein termed R̅_{b}, G̅_{b}, and B̅_{b} of all respective R_{b}, G_{b}, and B_{b} signals within such a region are calculated. The averages are used to calculate background values of α_{Rb} and α_{Bb}:

$${α}_{Rb} = \frac{\overline{{R}_{b}}}{\overline{{G}_{b}}} , {α}_{Bb} = \frac{\overline{{B}_{b}}}{\overline{{G}_{b}}}$$

Then, as shown at 503, non-background regions are located in the uncorrected initial image and analyzed in generally the same manner as described for the background regions. The non-background regions are chosen from substantially single-color regions, which have significantly different signal values from those for pixels in the background regions. Averages, herein termed R̅ₙ, G̅ₙ, and B̅ₙ of all respective Rₙ, Gₙ, and Bₙ, signals within such a region are calculated. The averages are used to calculate background values of α_{Rn} and α_{Bn}:

$${α}_{Rn} = \frac{\overline{{R}_{n}}}{\overline{{G}_{n}}} , {α}_{Bn} = \frac{\overline{{B}_{n}}}{\overline{{G}_{n}}} .$$

Based on the aforementioned non-background and background regions, the intensity and color of each pixel without the effect of the lateral color distortion is evaluated, as shown at 504. In particular, each pixel of the uncorrected initial image comprises a color that is substantially background, non-background, or a combination of background and non-background, and generates a signal “x.” Then, signal x and values of α_{Rb}, α_{Bb}, α_{Rn}, and α_{Bn} are used to generate intensity and color for each pixel. Most optionally, α_{B} and α_{R} for each pixel are calculated using a linear combination of:

$$\frac{{α}_{Bb}}{{α}_{Rb}} and \frac{{α}_{Bn}}{{α}_{Rn}} ,$$

the linear combination is a function of signal “x” compares to averaged background and non-background values for the specific pixel. Such values, as shown at 505, are then outputted as a lateral color correction that defines the chrominance and luminance for each pixel, thereby reduces or eliminates the effect of the lateral color aberration. Such a lateral color correction allows the generation of a chromatic correction. A detailed description of a process for correcting chromatic aberrations that may be used for identifying the chromatic correction is described in U.S. Pat. No. 6,876,763, issued on Apr. 5, 2005, which is incorporated herein by reference.

Reference is now made, once again, to FIG. 6.

As described above, the optical design of the designated optical unit creates the uncorrected initial image with uneven resolution at different areas thereof. Optionally, as described above, the uncorrected initial image is a chromatic space image that comprises a number, optionally three, of monochromatic space images. Each monochromatic space image is simulated or formed according to projections of monochromatic light beams, which are centered on a specific wavelength, from the designated optical unit. Optionally, the light beams are centered on R, G, and B wavelengths.

As shown at 304, steps 302 and 303 may repeatedly performed for identifying corrections for light beams centered on different wavelengths. Optionally, each step is repeated three times, each time for light beams, which are centered on one of the R, the G, and the B wavelengths. The monochromatic aberrations provide the uncorrected initial image with lateral color and uneven resolution.

As shown at 305, after monochromatic and chromatic corrections have been identified, an uneven resolution correction is identified. Optionally, before the uneven resolution is identified, the monochromatic and chromatic corrections are applied on the uncorrected initial image, thereby reduce the effect of the respective aberrations of the designated optical unit. By reducing or eliminating the uneven resolution in the image, the effect of monochromatic aberrations, such as tilt, coma, and astigmatism aberrations is reduced or eliminated. It should be noted that this process may be used for correcting uneven resolution in the uncorrected initial image.

Reference is now made, once again, to FIG. 1. As described above, during step 2 the optical design of the optical unit of the imaging device is set according to received specification. The optical unit of the optical design projects the uncorrected initial image, as described above. The optical unit of the optical design comprises predefined aberrations. Optionally, the optical unit projects the uncorrected initial image with different areas with uneven resolution. As further described above and shown at step 3, the monochromatic and chromatic algorithmic corrections and the uneven resolution algorithmic correction to the uncorrected initial image, which is formed by the optical unit, are calculated. As shown at 4, the compliance of an imaging device with the optical design that has been set in step 2 and the algorithmic correction thereto that has been calculated in step 3 is verified. Then, if needed, steps 2 and 3 may repeatedly performed for identifying algorithmic corrections for light beams centered on different wavelengths or for acquiring an optical design with an algorithmic correction that provides an output image with higher quality. Optionally, each step is repeated three times, each time for light beams, which are centered on one of the red, the green, and the blue wavelengths. It should be noted that the repeated steps may be performed in parallel. During the final step, as shown at 5, the optical design and the algorithmic corrections are outputted. Such data allows the generation of the designed imaging device that outputs an image without the predefined optical aberrations.

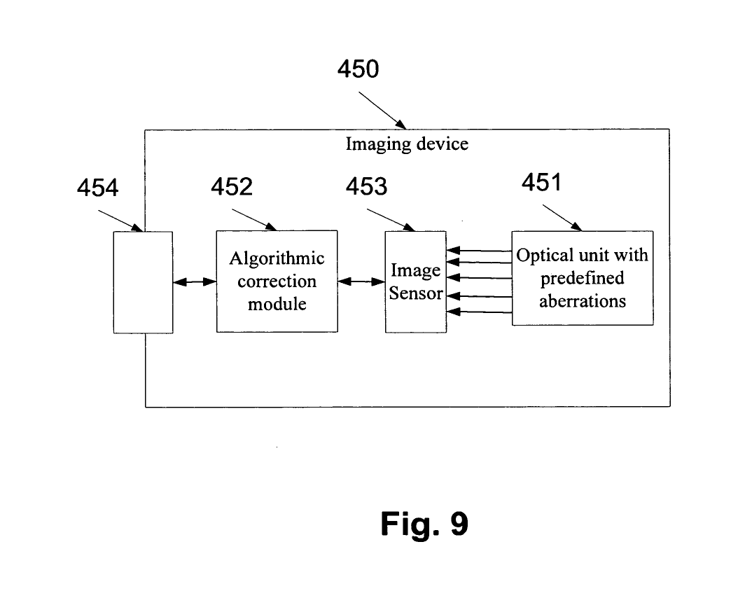

Reference is now made to FIG. 9, which is a schematic illustration of the imaging device 450 that is designed for outputting an image, according to one embodiment of the present invention. As described in FIG. 2, the imaging device 450 comprises the optical unit 451 that is generated according to the aforementioned optical design, the algorithmic correction module 452 that is defined according to the aforementioned algorithmic corrections, and the image sensor 453. However, unlike FIG. 2, FIG. 9 further comprises a designated output 454. The optical unit is defined with one or more optical aberrations, which are designed as described above, and projects an uncorrected initial image on the image sensor. The formed image optionally comprises different areas with uneven resolution, as described above. The algorithmic correction module 452, which is operatively connected to the image sensor 453, is defined with coefficients that compensate for the effect of the predefined optical aberrations on the image and optionally eliminate the effect of the uneven resolution thereon. The compensation allows the imaging device 450 to output an image, via the designated output 454, based on the uncorrected initial image, without the effect of the optical aberrations. Optionally, the imaging device 450 is a camera unit of a mobile device such as a mobile device, such as a laptop, a webcam, a mobile telephone, a PDA, display, a head mounted display (HMD), or the like.

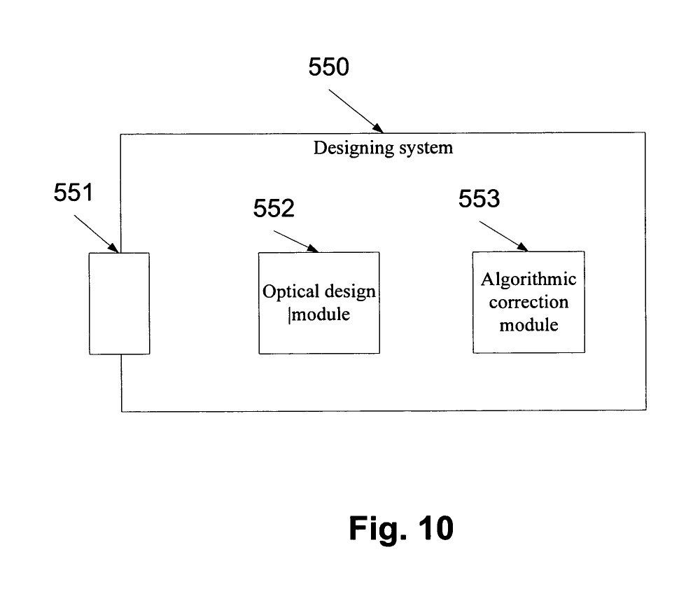

Reference is now made to FIG. 10, which is a schematic illustration of a system 550 for designing an imaging device, such as a camera module, having an optical unit that projects an uncorrected initial image, and a sensor, as described above, according to one embodiment of the present invention. The system 550 comprises an input module 551, an optical design module 552, and an algorithmic correction module 553. The input module 551 receives a specification of the imaging device that defines one or more optical aberrations of the optical unit. The optical design module 552 generates an optical design of the predefined optical unit according to the optical aberrations, which are defined in the specification. For example, the specification comprises predefined monochromatic aberrations, such as image distortion, and predefined chromatic aberrations, such as lateral color, as described above. Optionally, the specification defines uneven resolution to different areas of the uncorrected initial image, as described above. The algorithmic correction module 553 generates an algorithmic correction that compensates for the effect of the predefined optical aberration on the uncorrected initial image and optionally for corrects the uneven resolution. In such a manner, the designed imaging device outputs an image that is free from the effects of the predefined optical aberrations.

It is expected that during the life of this patent many relevant devices and systems will be developed and the scope of the terms herein, particularly of the terms an optical design and an image sensor are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An imaging apparatus for outputting a final image having a predefined mapping, the imaging apparatus comprising:
an image sensor;
an optical unit having an optical aberration, configured for projecting a uncorrected initial image on said image sensor; and
an optical algorithmic correction module, operatively connected to said image sensor, configured for compensating for the effect of said optical aberration on said uncorrected initial image according to at least one parameter defined according to said optical aberration, thereby allowing the outputting the final image without the effect produced by said optical aberration and with said predefined mapping.

2. The imaging apparatus of claim 1, wherein said uncorrected initial image comprises first and second areas, each said first and second area has a different predefined resolution.

3. The imaging apparatus of claim 2, wherein said optical algorithmic correction module is configured for calculating an even resolution for said first and second areas according to said different predefined resolution, said final image being generated according to said even resolution.

4. The imaging apparatus of claim 3, wherein said uncorrected initial image comprises red, green, and blue projections, said calculating comprises using a first resolution in said first area for compensating for a second resolution in said second area, said first resolution being higher than said second resolution in at least one of said projections.

5. The imaging apparatus of claim 1, wherein said compensating being performed by using a weight calculated for a plurality of different projections.

6. The imaging apparatus of claim 5, wherein said plurality of different projections comprises a projection from a member of the following group: a rectilinear object, a cylindrical object, a multi-planar object, and an ellipsoidal object.

7. The imaging apparatus of claim 3, wherein said optical aberration comprises a monochromatic aberration.

8. The imaging apparatus of claim 7, wherein said monochromatic aberration comprises a member of the following group: a tilt aberration, a defocus aberration, a spherical aberration, a coma aberration, an astigmatism aberration, a curvature of field aberration, an image distortion aberration, and a reflecting surface aberration.

9. The imaging apparatus of claim 1, wherein said optical aberration comprises a chromatic aberration.

10. The imaging apparatus of claim 9, wherein said chromatic aberration comprises a member of the following group: a longitudinal chromatic aberration and a transverse chromatic aberration.

11. The imaging apparatus of claim 9, said optical aberration having an image distortion aberration below 2%.

12. The imaging apparatus of claim 1, wherein said optic unit is an assembly having at least one optical element, said at least one optical element comprises a member of the following group: lenses, diffractive lenses, prisms, and mirrors.

13. The imaging apparatus of claim 12, wherein said optical aberration is related to said assembly having at least one optical element.

14. The imaging apparatus of claim 1, wherein said optical element is designed for providing wide field of view.

15. The imaging apparatus of claim 1, wherein said imaging apparatus is a member of the following group a laptop, a webcam, a mobile telephone, a personal digital assistant (PDA), a display, and a head mounted display (HMD).

16. An imaging apparatus for outputting a final image having a predefined mapping, the imaging apparatus comprising:
an image sensor;
an optical unit having an image distortion aberration above 5%, configured for projecting a uncorrected initial image on said image sensor; and
an optical algorithmic correction module, operatively connected to said image sensor, configured for compensating for the effect of said optical aberration on said uncorrected initial image, thereby allowing the outputting the final image without the effect of said optical aberration and with said predefined mapping.

17. An imaging apparatus for outputting a final image having a predefined mapping, the imaging apparatus comprising:
an image sensor;
an optical unit having a chromatic optical aberration, configured for projecting a uncorrected initial image with lateral color wider than an Airy disc of said image sensor; and
an optical algorithmic correction module, operatively connected to said image sensor, configured for compensating for the effect of said optical aberration on said uncorrected initial image, thereby allowing the outputting the final image without the effect of said optical aberration and with said predefined mapping.

18. An imaging apparatus for outputting a final image having a predefined mapping, the imaging apparatus comprising:
an image sensor;
an optical unit having a chromatic optical aberration, configured for projecting a uncorrected initial image with a first area and a second area on said image sensor, said first and second areas having different resolutions; and
an optical algorithmic correction module, operatively connected to said image sensor, configured for compensating for the effect of said optical aberration on said uncorrected initial image, thereby allowing the outputting the final image without the effect of said optical aberration and with said predefined mapping.

19. The imaging apparatus of claim 18, wherein said compensating comprises using information in said first area for compensating for the effect of said optical aberration on said second area.

20. The imaging apparatus of claim 18, wherein said first area has higher resolution with respect to the projection of one color wavelength than the respective resolution of said second area.

21. The imaging apparatus of claim 20, wherein said higher resolution is a modulation transfer function (MTF) value of at least 45% contrast at a half Nyquist frequency at the lower of said sensor and said optics unit.

22. A method for designing an imaging device, the method comprising:
a) receiving specification of a final image mapping a three-dimensional environment according to a predefined mapping and an optical unit with an optical aberration;
b) estimating an optical design of said optical unit with said optical aberration, said optical unit being configured for projecting a uncorrected initial image according to said optical aberration;
c) calculating an algorithmic correction for said uncorrected initial image, said algorithmic correction being configured for compensating for the effect of said optical aberration on said uncorrected initial image; and
d) manufacturing the imaging device, the manufactured imaging device having said optical design and applying said algorithmic correction on said uncorrected initial image, thereby outputting said final image.

23. The method of claim 22, wherein said specification defines first and second areas in said uncorrected initial image, each said first and second area has a different resolution.

24. The method of claim 22, wherein said specification defines a plurality of areas in said uncorrected initial image, each said plurality of areas has a different resolution.

25. The method of claim 23, wherein said designing comprises designing said optical unit to project said first and second areas in said uncorrected initial image.

26. The method of claim 23, further comprising a step d) of calculating an even resolution for said first and second areas, said algorithmic correction being configured for compensating for said different resolution according to said even resolution.

27. The method of claim 26, wherein said first and second areas are defined for a plurality of monochromatic light beams, each said monochromatic light beam being centered on a different wavelength, said calculating, each said first and second area has a high resolution in one of said definitions.

28. The method of claim 26, wherein said optical aberration comprises a monochromatic aberration.

29. The method of claim 26, wherein said optical aberration comprises a chromatic aberration.

30. The method of claim 29, further comprising a step c1) between step c) and d) of iteratively repeating said steps b) and c) until an image generated by applying said algorithmic correction on said uncorrected initial image comply with said specification.

31. The method of claim 29, wherein said optical aberration is defined by at least one parameter, said designing comprising the following steps:
a) defining said at least one parameter as respective target values in a merit function; and
b) identifying at least one temporary evaluated value that provides an optimal value of said merit function;
wherein said optical design is based on said at least one temporary evaluated value.

32. The method of claim 29, wherein uncorrected initial image comprises an image distortion produced by said optical aberration, said algorithmic correction being calculated using a calibration grid which projects a calibration image according to said image distortion.

33. The method of claim 22, wherein said predefined mapping maps at least one section of said three-dimensional environment into at least one section of said final image.

34. The method of claim 33, wherein each said at least one section of said three-dimensional environment is mapped into a respective said at least one section of said final image according to at least one member of the following group: a planer mapping, a multi-planer mapping, a cylindrical mapping, and a spherical mapping.

35. The method of claim 22, wherein said predefined mapping comprises a member of the following group: a planer mapping, a multi-planer mapping, a cylindrical mapping, and a spherical mapping.

36. The method of claim 29, wherein said specification defines said optical aberration.

37. A system for designing an imaging device, the system comprising:
an input module configured for receiving a specification of a final image mapping a three-dimensional environment according to a predefined mapping an optical unit having an optical aberration;
an optical design module configured for providing an optical design of said optical unit having said optical aberration, said optical unit being configured for projecting a distorted initial image;
an algorithmic correction module configured for generating an algorithmic correction for compensating for the effect of said optical aberration on said image, said algorithmic correction being defined according to said predefined mapping and said optical aberration; and
an output module configured for outputting said optical design and said algorithmic correction, thereby allowing the manufacturing of an imaging device configured for outputting said final image.

38. The system of claim 37, wherein said specification defines first and second areas in said image, each said first and second area has a different resolution.

39. The system of claim 38, wherein said optical design defines said optical unit to project said first and second areas.

40. The system of claim 39, wherein said algorithmic correction module is configured for generating an algorithmic correction that allows the generation of an image with an even resolution, said generating being performed according to said first and second areas.
